(19) United States
(12) Patent Application Publication
(10) Pub. No.: US 2005/0057566 A1
(43) Pub. Date: Mar. 17, 2005

(54) Rich graphic visualization generation from abstract data representation

(75) Inventors: Steven W. Githens, Skandia, MI (US); Peicheng Jing, Madison, WI (US); Cristina L. Liggett, Rochester, MN (US); Richard J. Stevens, Mantorville, MN (US)

Correspondence Address: William J. McGinnis, Jr.;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/660,143

(22) Filed: Sep. 11, 2003

(51) Int. Cl. G06T 11/20; G09G 5/00

(52) U.S. Cl. 345/440; 345/441; 345/442; 345/619

(57) ABSTRACT

A system, method and article of manufacture for generating graphical representations of data and, more particularly, for generating graphics rendering language for graphical representations of data. One embodiment provides a method of generating a graphical representation of data. The method comprises generating an abstract data structure defining a plurality of abstract attributes representing an abstract graphical representation of the data, and generating, on the basis of the abstract data structure, a concrete data structure defining a concrete graphical representation of the data in a graphics rendering language.

### CROSS-RELATED APPLICATION

This application is related to the following commonly owned application: U.S. patent application Ser. No. 10/083,075, filed Feb. 26, 2002, entitled “APPLICATION PORTABILITY AND EXTENSIBILITY THROUGH DATABASE SCHEMA AND QUERY ABSTRACTION”, which is hereby incorporated herein in its entirety.

### BACKGROUND OF THE INVENTION

1. Field of the Invention

The present invention generally relates to graphical representations of data and, more particularly, to generating graphics rendering language for graphical representations of data.

2. Description of the Related Art

Several methods are currently employed for defining static images. These methods can be broken down into two categories, binary encoding and vector-based textual description. Binary images are broken down pixel by pixel and are translated into binary representations stored in single files. Vector-based images take a different approach, describing an image by its characteristics rather than encoding it directly. Accordingly, static images can be specified in various languages or formats. Examples of binary encoded image formats include JPEG, GIF, and PNG. Examples of vector-based graphics languages include the Vector Markup Language (VML), Scalable Vector Graphics (SVG) and Hypertext Markup Language (HTML) Image Maps.

Vector-based graphics are suitable to define graphical representations of data, such as bar, line or pie charts. Such graphical representations are often used for visually analyzing complex data sets. For instance, a data set describing a distribution of revenues by month of a specific group of employees at different geographical locations in a country can be graphically rendered to visualize, e.g., revenue levels dependent on geographical locations. By graphically visualizing the information, for instance in a bar chart, the information can be captured and analyzed more easily.

One difficulty when dealing with vector-based graphics is accurately generating graphics rendering language for a graphical representation of a data set. More specifically, if a user wishes to create a graphical representation of a data set, he needs to move the data set to an existing graphics application to manually create and edit the graphical representation. Alternatively, the user can convert the data set into a graphic via a graphics rendering language using an appropriate application program, such as a conversion tool. The conversion tool is generally specific to the data source of the data set. Thus, if there are several different sources of data, a conversion tool for each data set is required.

For instance, assume a data set which should be graphically rendered using the SVG graphics rendering language. Current approaches for a generation of SVG graphics rendering language typically involves use of an authoring tool, such as Adobe® Illustrator® of Adobe Systems Inc., or an application program, such as Batik's SVGGraphics2D SVG generator available by the Apache Software Foundation. Using an authoring tool, a user may specify visual aspects of information contained in the data set to be rendered graphically. Using an application program, SVG graphics rendering language can automatically be generated from the data set.

However, both approaches are inconvenient and not user-friendly. The authoring tool approach has the drawback that a significant amount of user involvement is required each time a new data set is to be rendered graphically. The application program approach has the drawback that unique application code is required for each combination of data and graph type to be supported. In other words, common tasks such as graph scale computation and graph object layout and spacing must be re-implemented for each new data source and graph type.

More specifically, when currently working at the graphics rendering language level, issues specific to relative offset and size of graphical representations of data must be dealt with. For instance, assume the creation of a bar chart from a series of data points of a data set. Currently, the height of each bar (typically in pixels) must be computed based on the value associated with each bar and the scale required to represent all bars on one chart. Furthermore, a width for each bar must be computed, which is dependent on the number of bars to be graphed. Additionally, the placement of each bar relative to other bars and the axes of the chart must be computed. Substantial effort is required to map abstract data point values, such as revenue by month, into graphical constructs.

Therefore, there is a need for an effective mechanism for generating graphics rendering language for a graphical representation of data.

### SUMMARY OF THE INVENTION

The present invention is generally directed to a method, system and article of manufacture for generating graphical representations of data and, more particularly, to generating graphics rendering language for graphical representations of data.

One embodiment provides a method of generating a graphical representation of data. The method comprises generating an abstract data structure defining a plurality of abstract attributes representing an abstract graphical representation of the data, and generating, on the basis of the abstract data structure, a concrete data structure defining a concrete graphical representation of the data in a graphics rendering language.

Another embodiment comprises receiving a selection of a requested graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the requested graphical representation type and the selected abstract data structure template, an abstract data structure defining a plurality of abstract attributes abstractly representing the data set in the graphical representation, providing transformation rules for transforming the abstract data structure into a concrete data structure, the transformation rules describing graphical attributes of the requested graphical representation type, and generating, on the basis of the abstract data structure, a concrete data structure defining a concrete graphical representation in a graphics rendering language using the transformation rules.

Still another embodiment provides a method of generating an abstract data structure for a graphical representation of data. The method comprises providing a plurality of abstract data structure templates, each abstract data structure template being associated with a specific graphical representation type, determining a requested graphical representation type, selecting an abstract data structure template from the plurality of abstract data structure templates on the basis of the requested graphical representation type, and generating an abstract data structure using the selected abstract data structure template.

Still another embodiment provides a method of generating a graphical representation of data. The method comprises receiving a selection of a graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the selected abstract data structure template, an abstract data structure defining a logical representation of the data set graphically represented according to the selected graphical representation type, and transforming the abstract data structure into a graphics rendering language.

Still another embodiment comprises receiving abstract attribute values comprising at least a selection of a requested graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the received abstract attributes values and the selected abstract data structure template, an abstract data structure defining a plurality of abstract attributes abstractly representing the data set in the graphical representation, selecting transformation rules for transforming the abstract data structure into a concrete data structure from a plurality of transformation rules, the transformation rules describing graphical attributes of the requested graphical representation type, and generating, on the basis of the abstract data structure, a concrete data structure defining a concrete graphical representation in a graphics rendering language using the transformation rules.

Still another embodiment provides a computer readable medium containing a program which, when executed, performs a process of generating a graphical representation of data. The process comprises generating an abstract data structure defining a plurality of abstract attributes representing an abstract graphical representation of the data, and generating, on the basis of the abstract data structure, a concrete data structure defining a concrete graphical representation of the data in a graphics rendering language.

Still another embodiment provides a computer readable medium containing a program which, when executed, performs a process of generating a graphical representation of data. The process comprises receiving a selection of a requested graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the requested graphical representation type and the selected abstract data structure template, an abstract data structure defining a plurality of abstract attributes abstractly representing the data set in the graphical representation, retrieving transformation rules for transforming the abstract data structure into a concrete data structure, the transformation rules describing graphical attributes of the requested graphical representation type, and generating, on the basis of the abstract data structure, a concrete data structure defining a concrete graphical representation in a graphics rendering language using the transformation rules.

Still another embodiment provides a computer readable medium containing a program which, when executed, performs a process of generating an abstract data structure for a graphical representation of data. The process comprises retrieving a plurality of abstract data structure templates, each abstract data structure template being associated with a specific graphical representation type, determining a requested graphical representation type, selecting an abstract data structure template from the plurality of abstract data structure templates on the basis of the requested graphical representation type, and generating an abstract data structure using the selected abstract data structure template.

Still another embodiment provides a computer readable medium containing a program which, when executed, performs a process of generating a graphical representation of data. The process comprises receiving a selection of a graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the selected abstract data structure template, an abstract data structure defining a logical representation of the data set graphically represented according to the selected graphical representation type, and transforming the abstract data structure into a graphics rendering language.

Still another embodiment provides a computer readable medium containing a program which, when executed, performs a process of generating a graphical representation of data. The process comprises receiving abstract attributes values comprising at least a selection of a requested graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the received abstract attributes values and the selected abstract data structure template, an abstract data structure defining a plurality of abstract attributes abstractly representing the data set in the graphical representation, selecting transformation rules for transforming the abstract data structure into a concrete data structure from a plurality of transformation rules, the transformation rules describing graphical attributes of the requested graphical representation type, and generating, on the basis of the abstract data structure, a concrete data structure defining a concrete graphical representation in a graphics rendering language using the transformation rules.

Still another embodiment provides a computer comprising a database having data, and at least one graphics language framework residing in memory for generating graphics rendering language for the data. The at least one graphics language framework is configured for generating an abstract data structure defining a plurality of abstract attributes representing an abstract graphical representation of the data, and generating, on the basis of the abstract data structure, a concrete data structure defining a concrete graphical representation of the data in a graphics rendering language.

Still another embodiment provides a computer comprising a database having data, and at least one abstract data structure interface residing in memory for generating an abstract data structure for a graphical representation of the data. The at least one abstract data structure interface is configured for retrieving a plurality of abstract data structure templates, each abstract data structure template being associated with a specific graphical representation type, determining a requested graphical representation type, selecting an abstract data structure template from the plurality of abstract data structure templates on the basis of the requested graphical representation type, and generating an abstract data structure using the selected abstract data structure template.

Still another embodiment provides a computer comprising a database having data, and at least one graphics language framework residing in memory for generating graphics rendering language for the data. The at least one graphics language framework is configured for receiving a selection of a graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the selected abstract data structure template, an abstract data structure defining a logical representation of the data set graphically represented according to the selected graphical representation type, and transforming the abstract data structure into a graphics rendering language.

Still another embodiment provides a computer comprising a database having data, and at least one graphics language framework residing in memory for generating graphics rendering language for the data. The at least one graphics language framework is configured for receiving a selection of a requested graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the requested graphical representation type and the selected abstract data structure template, an abstract data structure defining a plurality of abstract attributes abstractly representing the data set in the graphical representation, retrieving transformation rules for transforming the abstract data structure into a concrete data structure, the transformation rules describing graphical attributes of the requested graphical representation type, and generating, on the basis of the abstract data structure, a concrete data structure defining a concrete graphical representation in a graphics rendering language using the transformation rules.

Still another embodiment provides a computer comprising a database having data, and at least one graphics language framework residing in memory for generating graphics rendering language for the data. The at least one graphics language framework is configured for receiving abstract attributes values comprising at least a selection of a requested graphical representation type for a selected data set, selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type, generating, on the basis of the received abstract attributes values and the selected abstract data structure template, an abstract data structure defining a plurality of abstract attributes abstractly representing the data set in the graphical representation, selecting transformation rules for transforming the abstract data structure into a concrete data structure from a plurality of transformation rules, the transformation rules describing graphical attributes of the requested graphical representation type, and generating, on the basis of the abstract data structure, a concrete data structure defining a concrete graphical representation in a graphics rendering language using the transformation rules.

### BRIEF DESCRIPTION OF THE DRAWINGS

So that the manner in which the above recited features of the present invention are attained can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the invention;

FIG. 2-4 are relational views of components implementing the invention;

FIG. 5 is a flow chart illustrating graphics rendering in one embodiment;

FIG. 6 is a screen shot illustrating an interface of a data source for graphics rendering in one embodiment;

FIG. 7 is a screen shot illustrating an interface for selecting a set of data to be rendered graphically from a data source and a set of abstract attribute values in one embodiment; and

FIG. 8 is a screen shot illustrating a rendered graphic in one embodiment.

### DETAILED DESCRIPTION OF THE PREFERRED EMBODIMENTS

Introduction

The present invention is generally directed to a method, system and article of manufacture for generating graphical representations of data and, more particularly, to generating graphics rendering language for graphical representations of data. According to one aspect, an abstract way for representing data and a method for generating a graphical representation of the data is provided, where the user neither participates in translation of the data into a graphics rendering language nor in rendering of the graphics on a display or other output device.

In one embodiment, a logical/abstract graphical representation is generated for data to be rendered graphically. The logical representation consists of an abstract data structure defining a plurality of attributes, and corresponding values, abstractly describing the graphical representation. The abstract data structure can be generated on the basis of information provided by a user or other requesting entity, such as an application. In either case, the requesting entity provides values for at least some of the abstract attributes. The abstract data structure can be defined in any suitable language, such as XML.

In one embodiment, the abstract data structure is based on a corresponding abstract data structure template. The template has a set of generalized abstract attributes (also referred to herein as “template attributes”) defined for a given graphical representation type. The template attributes are “placeholders” for which particular values for a specific graphical representation can be specified. In general, the particular values include chart values and data values. Accordingly, for a given graphical representation type, the abstract data structure template is not dependent on the specific data source. In other words, if the user uses many different data sources for a given graphical representation type, the abstract data structure template can be used for each data source. However, in one embodiment a different corresponding abstract data structure template is provided for each different graphical representation type.

In providing a plurality of abstract data structure templates, each related to a specific graphical representation type and independent of a given data source, a more abstract and standard way to represent data associated with a particular graphical representation type is provided. For instance, assume a BarChart data structure template that captures template attributes (such as title, background color, legend labels, values for each series of data, etc.) associated with a bar chart. These template attributes are more typical of the types of data available to a user or application and avoid any details concerning how the data is to be rendered in a graphical representation. Thus, the user (or application) only requires a high-level abstract knowledge of a desired graphical representation, to which the data should be rendered, without any specific low-level graphics rendering language knowledge.

On the basis of the abstract data structure, a concrete data structure defining the graphical representation of the data in a graphics rendering language can be generated. In one embodiment, the concrete data structure is generated by transforming the abstract data structure into the concrete data structure. A number of different technologies could be used for this purpose. For instance, where the abstract data structure is defined in XML, XSLT can be used to transform the abstract XML data structure into another XML data structure defining the graphics rendering language such as SVG on the basis of suitable transformation rules.

It should be appreciated that different methods of defining either the abstract data structure and/or the concrete data structure are contemplated. When using different methods, alternative transformation processes may be required which are designed to map from a corresponding different abstract data structure to a respective concrete data structure.

Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

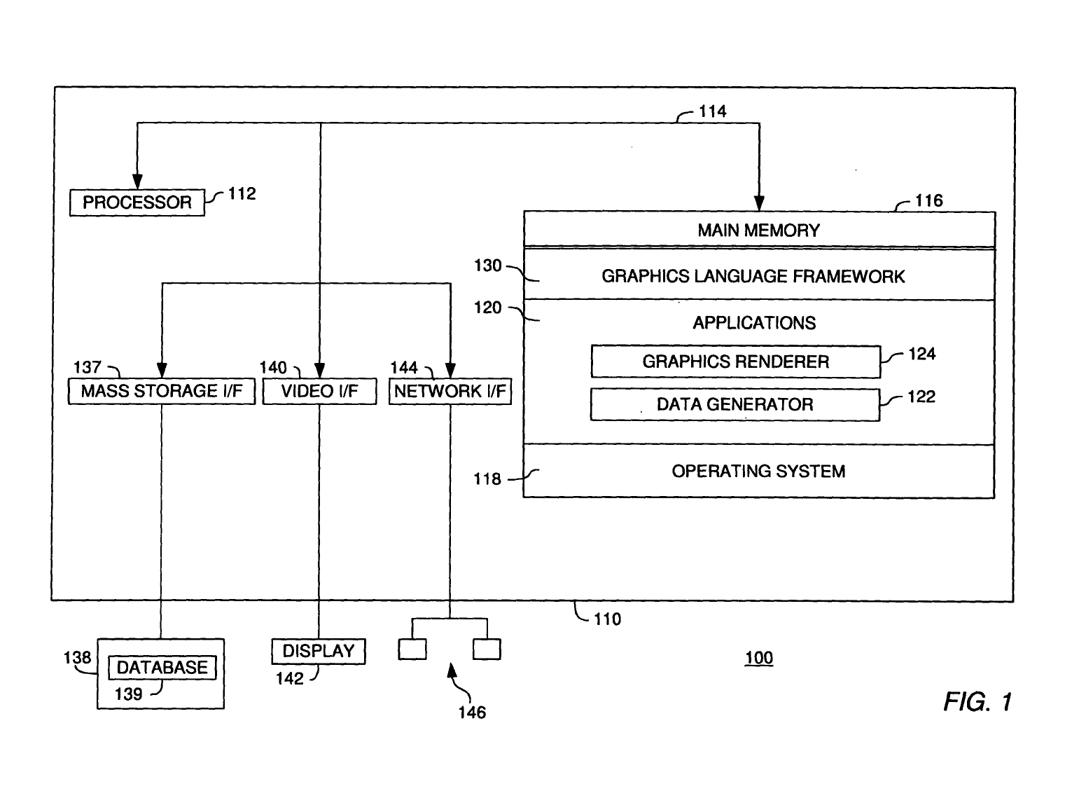

One embodiment of the invention is implemented as a program product for use with a computer system such as, for example, the computer system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

Referring now to FIG. 1, a computing environment 100 is shown. In general, the distributed environment 100 includes a computer system 110 and a plurality of networked devices 146. The computer system 110 may represent any type of computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. In one embodiment, the computer system 110 is an eServer iSeries available from International Business Machines of Armonk, N.Y.

Illustratively, the computer system 110 includes a networked system. However, the computer system 110 may also include a standalone device. In any case, it is understood that FIG. 1 is merely one configuration for a computer system. Embodiments of the invention can apply to any comparable configuration, regardless of whether the computer system 100 is a complicated multi-user apparatus, a single-user workstation, or a network appliance that does not have non-volatile storage of its own.

The embodiments of the present invention may also be practiced in distributed computing environments in which tasks are performed by remote processing devices that are linked through a communications network. In a distributed computing environment, program modules may be located in both local and remote memory storage devices. In this regard, the computer system 110 and/or one or more of the networked devices 146 may be thin clients which perform little or no processing.

The computer system 110 could include a number of operators and peripheral systems as shown, for example, by a mass storage interface 137 operably connected to a direct access storage device 138, by a video interface 140 operably connected to a display 142, and by a network interface 144 operably connected to the plurality of networked devices 146. The display 142 may be any video output device for outputting viewable information.

Computer system 110 is shown including at least one processor 112, which obtains instructions and data via a bus 114 from a main memory 116. The processor 112 could be any processor adapted to support the methods of the invention.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in a computer system 110, for example, any storage capacity used as virtual memory or stored on a mass storage device (e.g., direct access storage device 138) or on another computer coupled to the computer system 110 via bus 114.

The memory 116 is shown configured with an operating system 118. The operating system 118 is the software used for managing the operation of the computer system 100. Examples of the operating system 118 include IBM OS/400®, UNIX, Microsoft Windows®, and the like.

The memory 116 further includes one or more applications 120 and a graphics language framework 130. The applications 120 and the graphics language framework 130 are software products comprising a plurality of instructions that are resident at various times in various memory and storage devices in the computer system 100. When read and executed by one or more processors 112 in the computer system 100, the applications 120 and the graphics language framework 130 cause the computer system 100 to perform the steps necessary to execute steps or elements embodying the various aspects of the invention.

The graphics language framework 130 is configured to generate graphics rendering language for a graphical representation of data. The applications 120 include a data generator 122 for generating the data. More specifically, the data generator 122 exemplifies any software component (including the operating system 118) which is configured to generate data that is suitable to be rendered graphically on an output device, such as display 142. The data generator 122 can be implemented, e.g., as an input unit receiving data from a user or as a data querying application retrieving data from a database (e.g., database 139 shown in storage 138). In one embodiment, the data generator 122 is a Data Discovery and Query Builder available from International Business Machines of Armonk, N.Y. The database 139 is representative of any collection of data regardless of the particular physical representation of the data. By way of illustration, the database 139 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data. The applications 120 further include a graphics renderer 124 that exemplifies any software component which is configured for graphically rendering data on an output device, such as the display 142.

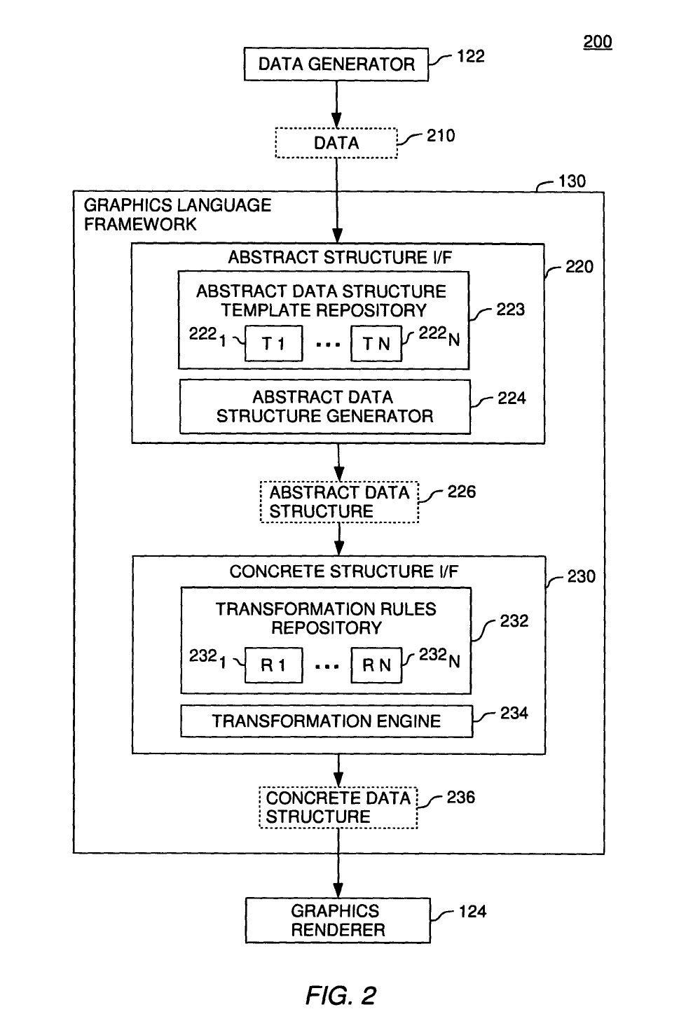

Illustratively, the data generator 122 and the graphics renderer 124 are shown as applications 120. However, each one or both of the data generator 122 and the graphics renderer 124 may alternatively be implemented as separate software components or, still alternatively, as part of the graphics language framework 130. The graphics language framework 130 is further described with reference to FIG. 2.

FIG. 2 shows an illustrative relational view 200 of components of the invention. The relational view 200 illustrates interaction of the data generator 122, the graphics language framework 130 and the graphics renderer 124 of FIG. 1 in one embodiment of the invention.

More specifically, the relational view 200 illustrates operation of the graphics language framework 130 for generating graphics rendering language for a graphical representation of data 210, which has been generated by the data generator 122. Illustratively, the graphics language framework 130 includes an abstract structure interface 220 and a concrete structure interface 230. The abstract structure interface 220 is configured to generate an abstract data structure 226 from the data 210. The abstract data structure 226 abstractly defines the graphical representation of the data 210. That is, the graphical representations generic with respect to any particular graphics rendering language. The concrete structure interface 230 is configured to generate a concrete data structure 236 from the abstract data structure 226. The concrete data structure 236 defines the graphical representation of the data 210 in a graphics rendering language. The graphics renderer 124 renders the concrete data structure 236 for output on a suitable output device, e.g., for display on a graphics display (e.g., display 142). Operation of the graphics language framework 130 and its constituent functions is described in the following.

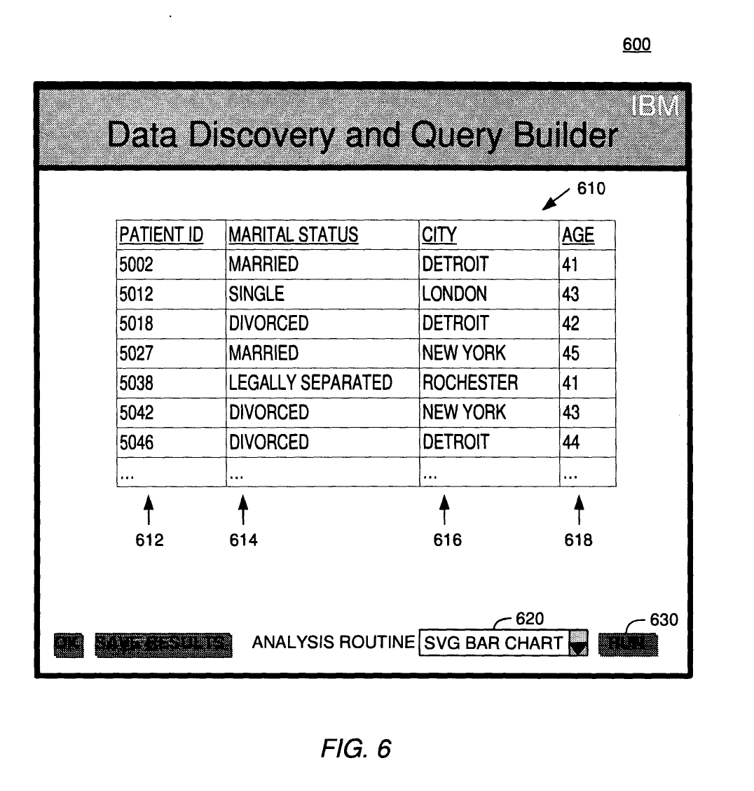

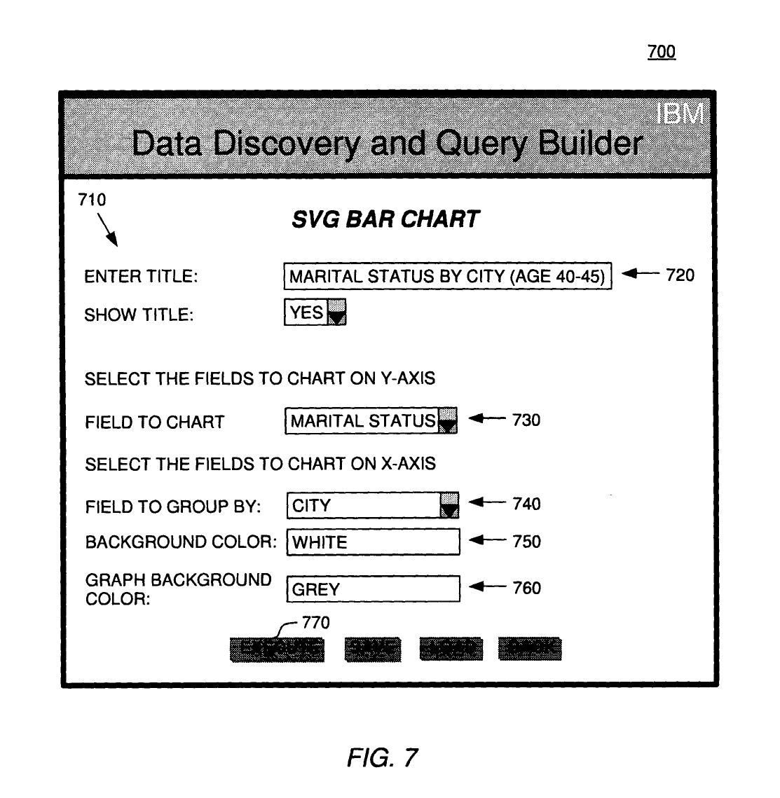

In one embodiment, the data 210 input to the abstract structure interface 220 is a query result obtained from a user's search on a database (e.g., database 139 of FIG. 1). By way of example, the query result can be obtained using IBM's Data Discovery and Query Builder, as illustrated in FIG. 6 (described below). Furthermore, the user can specify abstract attributes values through a user interface, as illustrated in FIG. 7 (described below). In one embodiment, a graphical representation type is specified by a corresponding abstract attribute value. According to the specified graphical representation type, the abstract structure interface 220 identifies a suitable abstract data structure template, hereinafter referred to as the template, from a plurality of templates 222₁, . . . 222_{N}. Illustratively, the plurality of templates 222 is maintained in an abstract data structure template repository 223, hereinafter referred to as the template repository 223.

Using the selected template, the abstract attributes values and the data 210, an abstract data structure generator 224 generates the abstract data structure 226. In one embodiment, generating the abstract data structure 226 consists in populating template attributes of the selected template with the abstract attributes values and the data items from the data 210, as will be described in more detail below.

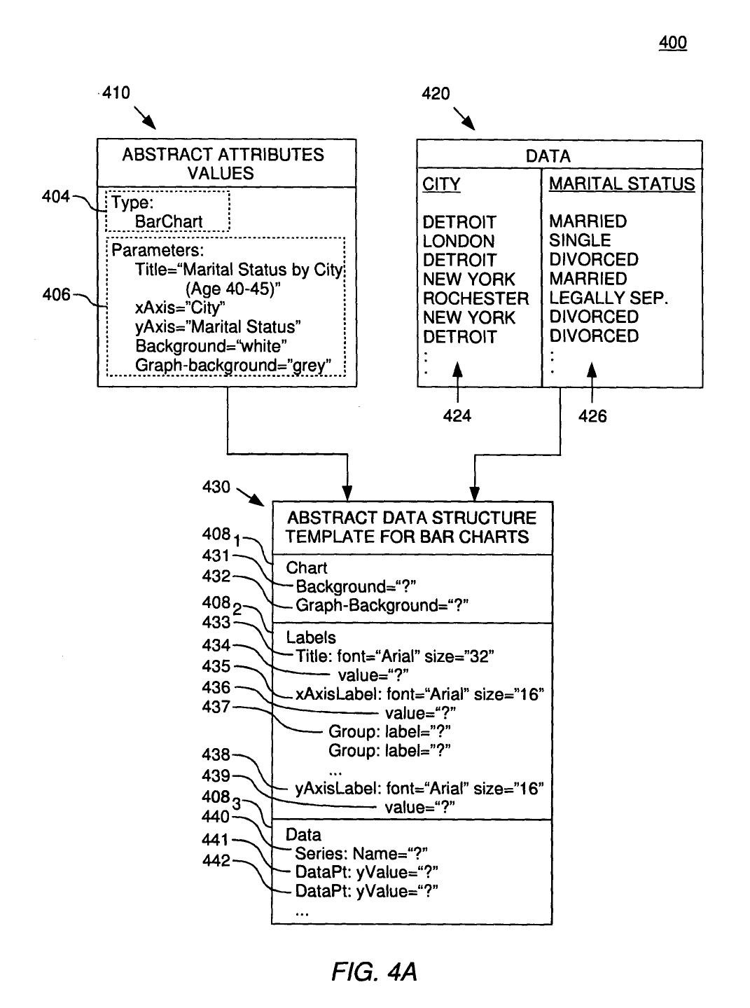

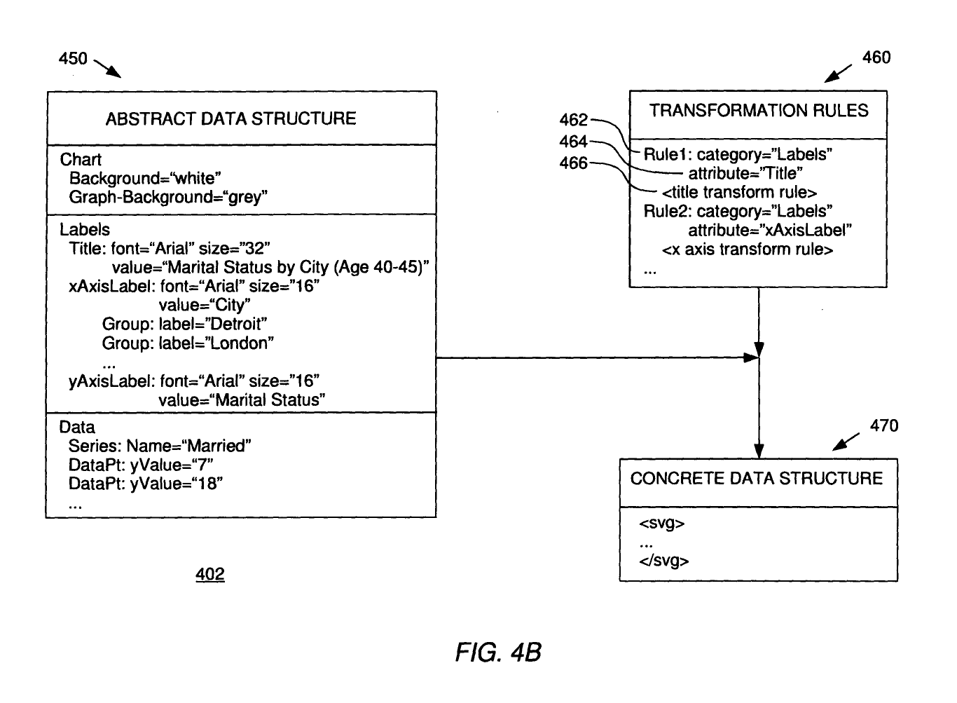

Referring now to FIG. 4A, a relational view 400 illustrating abstract attributes values 410, an exemplary data set 420 and an exemplary template 430 is shown. The abstract attributes values 410 illustratively define a graphical representation type 404 and graphical representation parameters 406. The template 430 is a template 222 selected from the template repository 223 according to the graphical representation type 404. Illustratively, the selected graphical representation type 404 is a bar chart. However, other graphical representation types available for selection include line charts, pie charts, scatter plots, and the like. Furthermore, it should be noted that any other graphical representation types, known or unknown, are contemplated.

In one embodiment, the graphical representation type 404 can be specified by a user using a graphical user interface (GUI), such as GUI 600 illustrated in FIG. 6. More specifically, GUI 600 includes a query result set 610 having a plurality of data items 612, 614, 616 and 618. Each one of the data items 612, 614, 616 and 618 corresponds to a column of one or more tables (e.g., of the database 139, shown in FIG. 1). Using a selection element 620, such as a drop down menu, or any other suitable means, the user selects the graphical representation type. In the illustrated example, the user selects “SVG BAR CHART” from the selection element 620 and, thus, requests to render the query result 610 in the form of a bar chart. Accordingly, the graphical representation type 404 specifies the type “BarChart”. The user illustratively validates their request by clicking the “RUN” button 630 in order to proceed with selecting the graphical representation parameters 406 (FIG. 4B).

In one embodiment, values for the graphical representation parameters 406 can be specified by the user using a GUI such as GUI 700 illustrated in FIG. 7. More specifically, GUI 700 includes a parameter specification section 710 having a plurality of parameter selection elements 720, 730, 740, 750 and 760. Using the selection element 720, the user can specify a title for the graphical representation. In the present example for the bar chart graphic, the user specifies the expression “Marital Status by City (Age 40-45)” as the chart title. Using the selection element 730, the user indicates a value to be represented on the y-axis of the bar chart. Illustratively, the user indicates that the data item 614 of FIG. 6, i.e., “Marital Status”, should be plotted on the y-axis. The selection of data item 614 is also represented by the data item 426 of the data set 420 shown in FIG. 4A. Using the selection field 740, the user indicates a value to be represented on the x-axis of the bar chart. Illustratively, the user indicates that the data item 616 of FIG. 6, i.e., “City”, should be plotted on the x-axis. The selection of data item 616 is also represented by the data item 424 of the data set 420 shown in FIG. 4A. Furthermore, the user indicates a background color and a graph background color using the selection fields 750 and 760, respectively. The thus specified values define the graphical representation parameters 406 as illustrated in FIG. 4A. The user illustratively validates the specification of the graphical representation parameters by clicking the “Execute” button 770 to execute rendering the query result 610 of FIG. 6 according to the selected abstract attributes values in a bar chart graphic.

An illustrative abstract attributes values description corresponding to the abstract attributes values 410 shown in FIG. 4A is shown in Table I below. By way of illustration, the illustrative abstract attributes values description is defined using XML. However, any other language may be used to advantage

TABLE I
ABSTRACT ATTRIBUTES VALUES EXAMPLE

| | |
|---|---|
| 001 | <?xml version=“1.0”?> |
| 002 | <!—Abstract Attributes Values representation: |
| | (Type = “BarChart”) --> |
| 003 | <Abstraction> |
| 004 | <Chart type=“BarChart” </Chart>> |
| 005 | <Parameters> |
| 006 | <Field name=“Title” value=“Marital Status by City |
| | (Age 40-45)”/> |
| 007 | <Field name=“xAxis” value=“City”/> |
| 008 | <Field name=“yAxis” value=“Marital Status”/> |
| 009 | <Field name=“Background” value=“white”/> |
| 010 | <Field name=“Graph-background” value=“grey”/> |
| 011 | </Parameters> |
| 012 | </Abstraction> |

Illustratively, the abstract attributes values shown in Table I include a ChartType specification (line 004) and a parameter specification (lines 005-011). In one embodiment, the parameter specification is a list of abstract fields that abstractly define graphical elements of the graphical representation. A parameter specification in the abstract attributes values may consist of a field name and an associated value.

On the basis of the graphical representation type 404, the template 430 for bar charts has been selected. That is, the template 430 represents selection of the appropriate one of the plurality of templates 222 contained in the template repository 223 (shown in FIG. 2). The template 430 is generally referred to herein as an “abstract template” because the template is composed according to template attributes rather than by direct reference to underlying concrete attributes of a particular graphical representation of data. As a result, using the abstract attributes values 410 and the exemplary data set 420 as input to the template 430, an abstract data structure 450 (shown in FIG. 4B and explained in more detail below) can be generated that is independent of the particular concrete representation to be generated.

In one embodiment, the template 430 includes a plurality of specifications 408₁, 408₂, and 408₃ (three shown by way of example), collectively referred to as the specifications 408. Specifically, a specification is provided for each template attribute available for composition of an abstract data structure. Each specification defines a category containing one or more template attributes. However, it should be appreciated that each template attribute can also be implemented separately from any category. Therefore, the representation shown in FIG. 4A is merely illustrative and not intended to limit the invention to categories of template attributes.

By way of example, a plurality of different template attributes 431-442 is shown. Each template attribute may have a defined value or take an input value. For example, the specification 408, “Chart” includes two template attributes, template attribute 431 “Background” and template attribute “Graph-Background”. As indicated by the symbol “?” for the template attributes 431 and 432, no value has been associated therewith. These template attributes take values from the parameters 406 or the data 420 to be graphed.

Furthermore, each template attribute may include abstract properties of a graphical representation of data. Each abstract property describes a graphical characteristic, like a font, a font size or a rotation, and has an associated value. Illustratively, the template attribute 433, “Title”, has abstract properties “font” and “size”. The abstract property “font” has the value “Arial” and the abstract property “size” has the value “32”. Accordingly, the title as defined by the value 434 will be displayed using the font “Arial” with the font size “32”.

An illustrative template 430 is shown in Table II below. By way of illustration, the illustrative template 430 is defined using XML. However, any other language may be used to advantage.

TABLE II
TEMPLATE EXAMPLE

| | |
|---|---|
| 001 | <?xml version=“1.0” encoding=“UTF-8”?> |
| 002 | <!-- ChartType=“BarChart” --> |
| 003 | - <chart background=“Background” barOrientation=“vertical” barType=“cluster” |
| 004 | detail=“true” gradient=“true” graphbackground=“Graph-background” |
| 005 | toolbar=“true” translucentBars=“false” viewHeight=“6” viewWidth=“8”> |
| 006 | <legend showObject=“true” xPosition=“right” yPosition=“center” /> |
| 007 | - <labels> |
| 008 | <title font=“Arial” showObject=“true” size=“32” styleBold=“false” |
| 009 | styleItalic=“false” styleUnderline=“false”> Title |
| 010 | </title> |
| 011 | <subtitle font=“Arial” showObject=“false” size=“16” styleBold=“false” |
| 012 | styleItalic=“false” styleUnderline=“false” /> |
| 013 | <xAxisLabel font=“Arial” showObject=“false” size=“16” styleBold=“false” |
| 014 | styleItalic=“false” styleUnderline=“false”>xAxis</xAxisLabel> |
| 015 | <yAxisLabel font=“Arial” showObject=“false” size=“12” styleBold=“false” |
| 016 | styleItalic=“false” styleUnderline=“false”>yAxis</yAxisLabel> |
| 017 | - <groupLabels font=“Arial” rotate=“30” showObject=“true” size=“12” |
| 018 | styleBold=“false” styleItalic=“false” styleUnderline=“false”> |
| 019 | <gLabel>Determine-gLabel-from-xAxis</gLabel> |
| 020 | </groupLabels> |
| 021 | <footnote font=“Arial” showObject=“false” size=“12” styleBold=“false” |
| 022 | styleItalic=“false” styleUnderline=“false” /> |
| 023 | </labels> |
| 024 | - <data> |
| 025 | - <dataSet> |
| 026 | - <scales> |
| 027 | - <xScale rangeType=“number” rotate=“30” xScrollbar=“true”> |
| 028 | - <numberFormat format=“default” precision=“0” |
| 029 | showLogScale=“false”> <logScale base=“10” /> |
| 030 | </numberFormat> |
| 031 | - <dateFormat format=“tempValue” /> |
| 032 | </xScale> |
| 033 | - <yScale rangeType=“number” rotate=“30” yScrollbar=“true”> |
| 034 | - <numberFormat format=“default” precision=“0” |
| 035 | showLogScale=“false”> <logScale base=“10” /> |
| 036 | </numberFormat> |
| 037 | <dateFormat format=“tempValue” /> |
| 038 | </yScale> |
| 039 | </scales> |
| 040 | <grid numberOfXLines=“9” numberOfYLines=“9” showXLine=“true” |
| 041 | showYLine=“true” xLineColor=“black” yLineColor=“black” /> |
| 042 | - <series fillPattern=“solid” fillcolor=“color” lineType=“solid” |
| 043 | pointSymbol=“filledCircle” seriesName=“yAxis-value” symbolSize=“8”> |
| 044 | <dataPt xValue=“0.0” yValue=“glabel-yAxis-value-total” /> |
| 045 | </series> |
| 046 | </dataSet> |
| 047 | </data> |
| 048 | </chart> |

Note that, for instance, lines 003-006 provide a generic abstract description of characteristics of a bar chart. Furthermore, the elements shown in bold letters in lines 003, 004, 009, 014 and 016 are placeholders where abstract attributes values obtained, for instance, from Table I can be plugged in. The elements shown in bold letters in lines 019, 042, 043 and 044 are elements which need to be determined from a corresponding data set (e.g., data set 420 of FIG. 4A) to be rendered graphically.

Referring now back to FIG. 2 (in combination with FIGS. 4A and 4B), generation of the abstract data structure 226 is explained in more detail. Illustratively, the abstract data structure generator 224 selects a suitable template (e.g., template 430) and populates the template attributes of the template with the abstract attributes values 410 and data items 420, thereby producing an abstract data structure 450. As a result, the abstract data structure 450 is obtained. In other words, the abstract data structure 450 is a populated instance of the template 430, wherein values have been plugged in for all of the template attributes and the data items.

Assume that the abstract data structure 450 is a populated instance of the template of Table II, the abstract attributes values are the abstract attributes values of Table I and the data items are determined from the query result 610 illustrated in FIG. 6. A corresponding representation of the abstract data structure 450 is illustrated in Table III. By way of illustration, the abstract data structure is defined using XML. However, any other language may be used to advantage. Furthermore, for purposes of illustration, the values taken by expressions in the template of Table II (illustrated in bold letters) are indicated in bold letters in Table III below.

TABLE III
ABSTRACT DATA STRUCTURE EXAMPLE

| | |
|---|---|
| 001 | <?xml version=“1.0” encoding=“UTF-8” ?> |
| 002 | <!-- ChartType=“BarChart” --> |
| 003 | - <chart background=“grey” barOrientation=“vertical” barType=“cluster” |
| 004 | detail=“true” gradient=“true” graphbackground=“white” toolbar=“true” |
| 005 | translucentBars=“false” viewHeight=“6” viewWidth=“8”> |
| 006 | <legend showObject=“true” xPosition=“right” yPosition=“center” /> |
| 007 | - <labels> |
| 008 | <title font=“Arial” showObject=“true” size=“32” styleBold=“false” |
| 009 | styleItalic=“false” styleUnderline=“false”>Marital Status by City (Age 40- |
| 010 | 45)</title> |
| 011 | <subtitle font=“Arial” showObject=“false” size=“16” styleBold=“false” |
| 012 | styleItalic=“false” styleUnderline=“false” /> |
| 013 | <xAxisLabel font=“Arial” showObject=“false” size=“16” styleBold=“false” |
| 014 | styleItalic=“false” styleUnderline=“false”>City</xAxisLabel> |
| 015 | <yAxisLabel font=“Arial” showObject=“false” size=“12” styleBold=“false” |
| 016 | styleItalic=“false” styleUnderline=“false”>Marital Status</yAxisLabel> |
| 017 | - <groupLabels font=“Arial” rotate=“30” showObject=“true” size=“12” |
| 018 | styleBold=“false” styleItalic=“false” styleUnderline=“false”> |
| 019 | <gLabel>D troit</gLabel> |
| 020 | <gLabel>London</gLabel> |
| 021 | </groupLabels> |
| 022 | <footnote font=“Arial” showObject=“false” size=“12” styleBold=“false” |
| 023 | styleItalic=“false” styleUnderline=“false” /> |
| 024 | </labels> |
| 025 | - <data> |
| 026 | - <dataSet> |
| 027 | - <scales> |
| 028 | - <xScale rangeType=“number” rotate=“30” xScrollbar=“true”> |
| 029 | - <numberFormat format=“default” precision=“0” |
| 030 | showLogScale=“false”> <logScale base=“10” /> |
| 031 | </numberFormat> |
| 032 | - <dateFormat format=“tempValue” /> |
| 033 | </xScale> |
| 034 | - <yScale rangeType=“number” rotate=“30” yScrollbar=“true”> |
| 035 | - <numberFormat format=“default” precision=“0” |
| 036 | showLogScale=“false”> <logScale base=“10” /> |
| 037 | </numberFormat> |
| 038 | <dateFormat format=“tempValue” /> |
| 039 | </yScale> |
| 040 | </scales> |
| 041 | <grid numberOfXLines=“9” numberOfYLines=“9” showXLine=“true” |
| 042 | showYLine=“true” xLineColor=“black” yLineColor=“black” /> |
| 043 | - <series fillPattern=“solid” fillcolor=“red” lineType=“solid” |
| 044 | pointSymbol=“filledCircle” seriesName=“Married” symbolSize=“8”> |
| 045 | <dataPt xValue=“0.0” yValue=“6” /> |
| 046 | <dataPt xValue=“0.0” yValue=“3” /> |
| 047 | </series> |
| 048 | - <series fillPattern=“solid” fillcolor=“blue” lineType=“solid” |
| 049 | pointSymbol=“filledCircle” seriesName=“Divorced” symbolSize=“8”> |
| 050 | <dataPt xValue=“0.0” yValue=“7” /> |
| 051 | <dataPt xValue=“0.0” yValue=“18” /> |
| 052 | </series> |
| 053 | </dataSet> |
| 054 | </data> |
| 055 | </chart> |

More specifically, the abstract data structure generator 224 determines the abstract attributes values “Background”, “Graph-background”, “Title”, “xAxis” and “yAxis” from Table I and plugs the determined values into the selected template. Accordingly, the values “white” for “background”, “grey” for “Graph-background”, “Marital Status by City (Age 40-45)” for “Title”, “City” for “xAxis” and “Marital Status” for “yAxis” are determined from Table I and have been introduced into lines 003, 004, 009, 014 and 016 of the selected template. Accordingly, lines 003, 004, 009, 010, 014 and 016 of Table II are obtained. Furthermore, the abstract data structure generator 224 determines one or more group labels grouping data items on the determined x-axis from the query result 610 of FIG. 6. In one embodiment, for each determined group label a copy of line 019 of the selected template is created. Thus, all determined group labels can be plugged into the selected template instead of the copied expression “Determine-gLabel-from-xAxis” (illustrated in bold letters in line 019 of the selected template). For the query result example of FIG. 6, the group labels “Detroit” and “London” are determined. For brevity, only two different group labels are illustrated. Accordingly, lines 019 and 020 of Table III are obtained. Furthermore, the abstract data structure generator 224 determines all data values occurring on the determined y-axis. For each determined data value a copy of lines 042-045 of the selected template is created. Thus, all determined data values can be introduced into the selected template instead of the copied expression “yAxis-value” (illustrated in bold letters in line 043 of the selected template). Accordingly, the data values “Married” and “Divorced” are determined from the query result 610 of FIG. 6. For brevity, only two different data values are illustrated. Accordingly, lines 042-045 are copied once and, thus, lines 043-052 are obtained. The data values are introduced into lines 044 and 049 of Table III instead of the corresponding expressions “yAxis-value” (illustrated in bold letters in line 043 of the selected template). It should be appreciated that for each copy of lines 042-045 (i.e., lines 043-047 and 048-052) a different color “color” (illustrated in bold letters in line 042 of the selected template) can be selected automatically. Accordingly, in the given example the colors “red” and “blue” may be selected and specified in lines 043 and 048 of Table III respectively. Furthermore, line 044 of the selected template and each copy thereof (i.e., lines 045 and 050 in Table III) are copied according to the number of determined group labels. Accordingly, lines 046 and 051 of Table III are obtained. For each group label, a total amount representing an overall occurrence of each determined data value is calculated. For instance, it is assumed that the data value “Married” occurs 6 times for the group label “Detroit” and 3 times for the group label “London”. The determined total amounts are introduced instead of the expression “glabel-yAxis-value-total” at appropriate locations in the selected template. Accordingly, lines 045, 046, 050 and 051 of Table III are obtained.

Referring now back to FIG. 2, generation of a concrete data structure 236 by the concrete structure interface 230 is explained in more detail. The concrete structure interface 230 is configured to receive the abstract data structure 226. Dependent on the graphical representation type (e.g., graphical representation type 404 of FIG. 4) specified by the user, the concrete structure interface 230 identifies a suitable set of transformation rules from a plurality of transformation rules. Illustratively, the plurality of transformation rules is maintained in a transformation rules repository 232, hereinafter referred to as the rule repository. By way of example, the rule repository 232 includes two transformation rules, rule R1 232₁ and rule RN 232_{N}. In one embodiment, each one of the transformation rules R1 232₁ and rule RN 232_{N} defines a set of transformation rules configured for transformation of an abstract data structure into a graphical representation having a particular graphical representation type. Using the suitable set of transformation rules, a transformation engine 234 generates the concrete data structure 236 on the basis of the abstract data structure 226. In one embodiment, generating the concrete data structure 236 consists in transforming the abstract data structure 226 into the concrete data structure 236 according to the suitable set of transformation rules. The suitable transformation rules can be specific to a particular graphical representation type, such as for bar charts, line charts, pie charts or scatter plots. The transformation rules can also be specific to the concrete data structure type. In other words, different transformation rules can be provided for different graphics rendering languages to be generated, such as transformation rules specific to SVG, or Java 2D transformations.

In the example described above with reference to FIGS. 4B, 6 and 7, the transformation engine 234 uses transformations rules 460 to transform the abstract data structure 450 into concrete data structure 470. Illustrative transformation rules corresponding to the transformation rules 460 shown in FIG. 4B are shown in Table IV below. By way of illustration, the illustrative transformation rules are defined using Extensible Stylesheet Language Transformations (XSLT). However, any other language may be used to advantage.

TABLE IV
TRANSFORMATION RULES EXAMPLE

| | |
|---|---|
| 001 | <xsl:template match=“labels/title” mode=“display”> |
| 002 | <!--displays the label for the title--> |
| 003 | <text x=“100” y=“10” font-size=“{ @ size}” font-family=“{ @ font}” > |
| 004 | <xsl:apply-templates select=“//title”/> |
| 005 | </text> |
| 006 | </xsl:template> |
| 007 | <xsl:template match=“labels/xAxisLabel” mode=“display”> |
| 008 | <!--displays the label for the x axis--> |
| 009 | <text x=“100” y=“400” font-size=“{ @ size}” font-family=“{ @ font}” > |
| 010 | <xsl:apply-templates select=“//xAxisLabel”/> |
| 011 | </text> |
| 012 | </xsl:template> |
| 013 | <xsl:template match=“labels/yAxisLabel” mode=“display”> |
| 014 | <!--displays the label for the y axis--> |
| 015 | <g transform=“rotate(270)”> |
| 016 | <text x=“50” y=“100” font-size=“{ @ size}” font-family=“{ @ font}” > |
| 017 | <xsl:apply-templates select=“//yAxisLabel”/> |
| 018 | </text> |
| 019 | </g> |
| 020 | </xsl:template> |

Illustratively, the transformation rules shown in Table IV include a transformation rule for transforming a title of the graphical representation (lines 001-006), a transformation rule for transforming an x-axis label (lines 007-012) and a transformation rule for transforming a y-axis label (lines 013-020). The transformation rules illustrated in Table IV are based on XSLT and configured to convert an XML abstract chart representation to SVG graphics rendering language. For instance, the transformation rules specified in lines 001-006 define how the title for the graphical representation is to be rendered graphically on the basis of values (“size” and “font” in line 003 and “title” in line 004) provided by the abstract data structure.

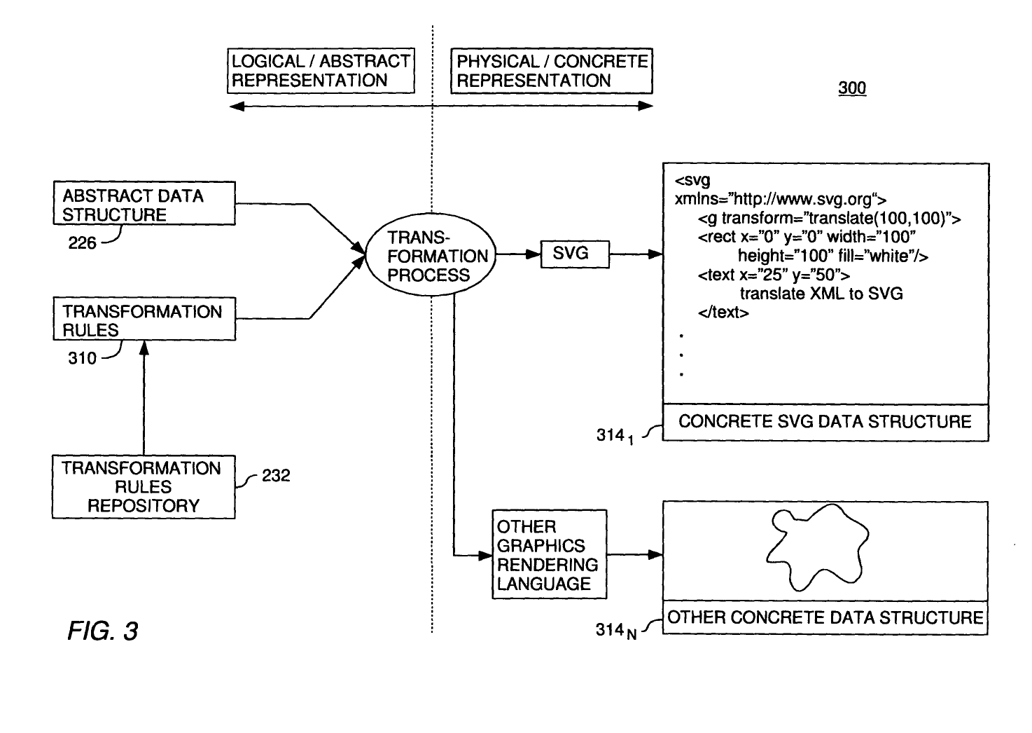

A transformation process for generating a concrete data structure (i.e., concrete data structure 314₁ or 314_{N}) from the abstract data structure 226 using transformation rules (i.e., transformation rules 310) is illustrated in FIG. 3. The concrete data structure can be defined by a graphics rendering language. The graphics rendering language can be a vector-based graphics language such as Vector Markup Language (VML), Scalable Vector Graphics (SVG) or Hypertext Markup Language (HTML) Image Maps. Illustratively, the concrete data structure is shown as an SVG concrete data structure 3141. However, as illustrated by the other concrete data structure ³¹⁴N, various other graphics rendering languages are contemplated and the invention is not intended to be limited to a particular graphics rendering language, such as SVG. Furthermore, the abstract data structure can be transformed to multiple graphics rendering languages without the user (or application) having to provide specific implementations for each target graphical rendering technology. More specifically, the requested graphical representation type (e.g., graphical representation type 404 of FIG. 4A) can be rendered via SVG or any other graphics rendering language by simply providing suitable transformation rules between abstract and concrete data structure. In other words, the graphics language framework 130 of FIG. 1 can be configured for rendering any known or unknown graphics rendering language on the basis of a given abstract data structure by using suitable transformation rules.

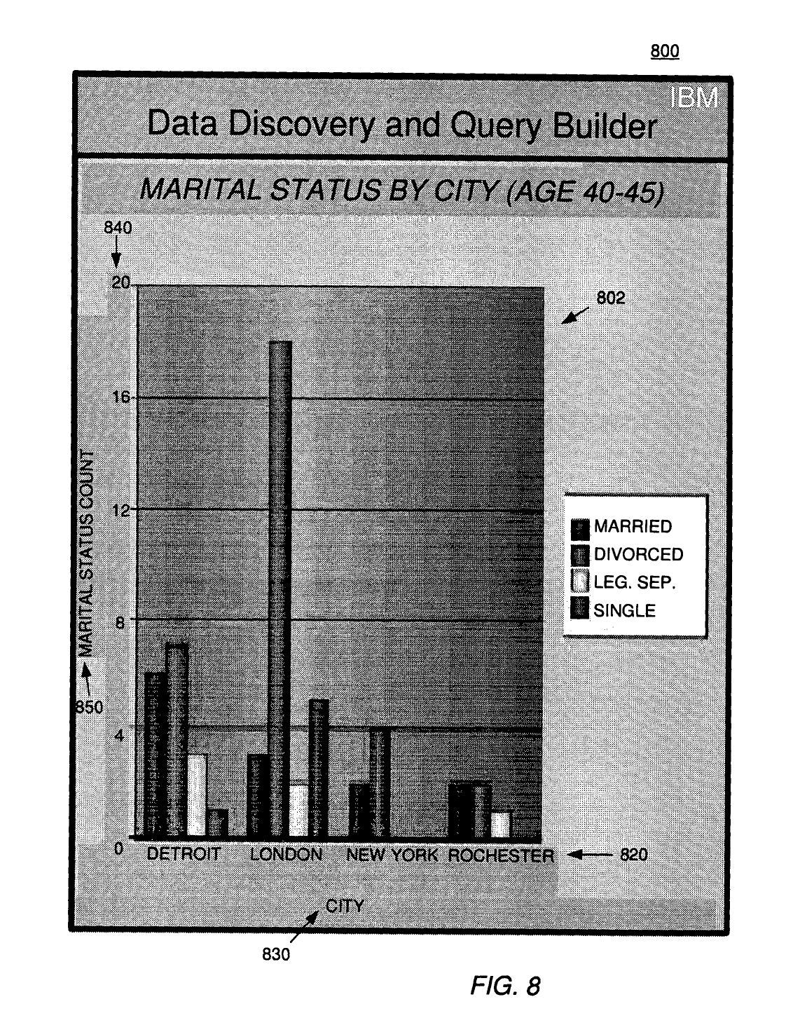

Referring now back to FIG. 2, the graphics renderer 124 renders the concrete data structure 236 graphically for output on a suitable output device. For instance, the graphics renderer 124 renders a graphical representation on a graphics display (e.g., display 142). In one embodiment, the graphical representation can be viewed and manipulated in a web browser, such as Microsoft's Internet Explorer or Netscape's Navigator, using an appropriate plug-in. A graphical representation corresponding to a concrete data structure generated on the basis of the abstract data structure illustrated in Table III is shown in FIG. 8.

More specifically, FIG. 8 illustrates a graphical representation 800 of the data defined by the query result 610 of FIG. 6. The graphical representation 800 consists of a bar chart 802 which has been created on the basis of the abstract data structure illustrated in Table III above. Accordingly, the bar chart 802 groups a plurality of different cities (“Detroit”, “London”, New York” and “Rochester”) on an x-axis 830 labeled “City”. The bar chart further shows data values 840 forming a y-axis 850 labeled “Marital Status Count”.

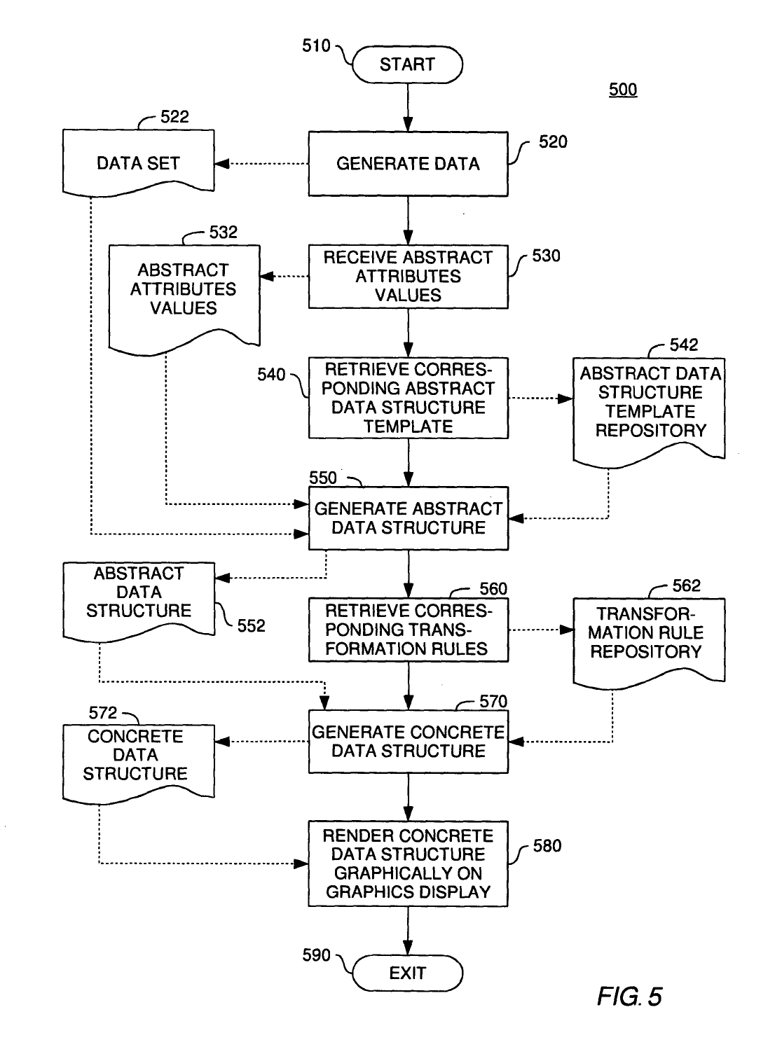

Referring now to FIG. 5, an exemplary method 500 for generation of graphics rendering language for a graphical representation of data is illustrated. In one embodiment, the method 500 is performed by the data generator 122, the graphics language framework 130 and the graphics renderer 124 of FIG. 2. The method 500 starts at step 510.

In step 520, the data (e.g., query result 610 of FIG. 6) is generated. The generated data is stored in memory (e.g., main memory 116 of FIG. 1) as a data set 522 (e.g. data 420 of FIG. 4A) for rendering. In step 530, abstract attributes values 532 (e.g., abstract attributes values 410 of FIG. 4A) are received. In one embodiment, the abstract attributes values are specified using a graphical user interface (e.g., GUI 700 of FIG. 7). The abstract attributes values 532 are also stored in the memory. The abstract attributes values 532 may specify data items (e.g., data items 424 and 426 of FIG. 4A) from the generated data which should be rendered graphically. The data items can define a subset of the generated data illustrated as the data set 522.

In step 540, a corresponding suitable abstract data structure template (e.g., template 430) is retrieved from a template repository 542 (e.g., template repository 223 of FIG. 2). The suitable template can be identified on the basis of a graphical representation type (e.g., graphical representation type 404 of FIG. 4A). The graphical representation type can be selected, for example, using a graphical user interface (e.g., GUI 600 of FIG. 6).

In step 550, an abstract data structure 552 (e.g., abstract data structure 450 of FIG. 4B) is generated using the data set 522, the abstract attributes values 532 and the suitable template. In step 560, one or more corresponding suitable transformation rules (e.g., transformation rules 460) describing graphical attributes of the graphical representation type are retrieved from a transformation rules repository 562 (e.g., transformation rules repository 232 of FIG. 2). The suitable transformation rule(s) can be identified on the basis of the graphical representation type.

In step 570, a concrete data structure 572 (e.g., concrete data structure 470 of FIG. 4B) is generated on the basis of the abstract data structure 552. The concrete data structure 572 is generated using the suitable transformation rule(s).

In step 580, the concrete data structure 572 is graphically rendered for output on an output device. Illustratively, the concrete data structure 572 is rendered for output on a graphics display (e.g., display 142 of FIG. 1). Method 500 then exits at step 590.

In various embodiments, the invention provides numerous advantages over the prior art. Embodiments of the invention simplify generation of graphics rendering language for a graphical representation of data. For instance, one embodiment enables a database programmer to provide users with a software tool allowing users to select a graphical representation of data. Thus, a user can define a data set to be rendered graphically. The software tool converts the selections of the user's data set to an abstract data structure using the abstract data structure templates. Then, the graphics language framework performs a transformation of the abstract data structure into a graphical format without further user interaction.

Furthermore, embodiments of the invention can be implemented in an abstraction component for logically viewing physical data. Such an abstraction component is disclosed in commonly assigned U.S. patent application Ser. No. 10/083,075 (the '075 application), filed Feb. 22, 2002 entitled “Improved Application Flexibility Through Database Schema and Query Abstraction”, and is hereby incorporated by reference in its entirety. The abstraction component of the '075 application provides a requesting entity (i.e., an end-user or application) with an abstract representation of physical data. In other words, the abstraction component of the '075 application provides the requesting entity with an abstract data model that logically describes an underlying physical data structure. In this way, the requesting entity is decoupled from the underlying physical data to be accessed. Logical queries based on the abstraction component can be constructed without regard for the makeup of the physical data. Further, changes to the physical data do not necessitate changes to applications accessing the physical data. Accordingly, embodiments of the invention may be practiced in the abstraction component of the '075 application using logical representations of queries as a basis for generation of abstract data structures.

While the foregoing is directed to embodiments of the present invention, other and further embodiments of the invention may be devised without departing from the basic scope thereof, and the scope thereof is determined by the claims that follow.

1. A method of generating a graphical representation of data, comprising:
generating an abstract data structure defining a plurality of abstract attributes representing an abstract graphical representation of the data; and
generating, on the basis of the abstract data structure, a concrete data structure defining a concrete graphical representation of the data in a graphics rendering language.

2. The method of claim 1, further comprising:
providing a plurality of abstract data structure templates, each abstract data structure template being associated with a specific graphical representation type;
determining a requested graphical representation type;
selecting an abstract data structure template from the plurality of abstract data structure templates on the basis of the requested graphical representation type; and
generating the abstract data structure using the selected abstract data structure template.

3. The method of claim 2, wherein the requested graphical representation type is one of a bar chart, a line chart, a pie chart, a scatter plot and a combination thereof.

4. The method of claim 2, wherein the plurality of abstract data structure templates is associated with a particular data source of the data.

5. The method of claim 1, further comprising:
providing transformation rules for transforming the abstract data structure into the concrete data structure, the transformation rules describing graphical attributes of a requested graphical representation type; and
generating the concrete data structure using the transformation rules.

6. The method of claim 5, wherein generating the concrete data structure using the transformation rules comprises:
selecting a subset of the transformation rules in accordance with the requested graphical representation type; and
generating the concrete data structure using the subset of the transformation rules.

7. The method of claim 6, wherein the requested graphical representation type is one of a bar chart, a line chart, a pie chart, a scatter plot and a combination thereof.

8. The method of claim 1, wherein at least one of the abstract data structure and the concrete data structure is defined in Extensible Markup Language (XML).

9. The method of claim 1, wherein the concrete data structure is defined in a vector-based graphics language.

10. The method of claim 9, wherein the vector-based graphics language is one of Vector Markup Language (VML), Scalable Vector Graphics (SVG), and Hypertext Markup Language (HTML) Image Maps.

11. A method of generating a graphical representation of data, comprising:
receiving a selection of a requested graphical representation type for a selected data set;
selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type;
generating, on the basis of the requested graphical representation type and the selected abstract data structure template, an abstract data structure defining a plurality of abstract attributes abstractly representing the data set in the graphical representation;
providing transformation rules for transforming the abstract data structure into a concrete data structure, the transformation rules describing graphical attributes of the requested graphical representation type; and
generating, on the basis of the abstract data structure, a concrete data structure defining a concrete graphical representation in a graphics rendering language using the transformation rules.

12. The method of claim 11, further comprising:
rendering the data set, as described in the graphics rendering language, in a graphic.

13. The method of claim 11, wherein the graphical representation type is one of a bar chart, a line chart, a pie chart, a scatter plot and a combination thereof.

14. The method of claim 11, wherein the plurality of abstract data structure templates is associated with a particular data source of the data.

15. The method of claim 11, further comprising:
selecting a subset of the transformation rules in accordance with the graphical representation type; and
generating the concrete data structure using the subset of the transformation rules.

16. The method of claim 11, wherein at least one of the abstract data structure and the concrete data structure is defined in Extensible Markup Language (XML).

17. The method of claim 11, wherein the concrete data structure is defined in a vector-based graphics language.

18. The method of claim 17, wherein the vector-based graphics language is one of Vector Markup Language (VML), Scalable Vector Graphics (SVG), and Hypertext Markup Language (HTML) Image Maps.

19. A method of generating an abstract data structure for a graphical representation of data, comprising:
providing a plurality of abstract data structure templates, each abstract data structure template being associated with a specific graphical representation type;
determining a requested graphical representation type;
selecting an abstract data structure template from the plurality of abstract data structure templates on the basis of the requested graphical representation type; and
generating an abstract data structure using the selected abstract data structure template.

20. A method of generating a graphical representation of data, comprising:
receiving a selection of a graphical representation type for a selected data set;
selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type;
generating, on the basis of the selected abstract data structure template, an abstract data structure defining a logical representation of the data set graphically represented according to the selected graphical representation type; and
transforming the abstract data structure into a graphics rendering language.

21. A method of generating a graphical representation of data, comprising:
receiving abstract attributes values comprising at least a selection of a requested graphical representation type for a selected data set;
selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type;
generating, on the basis of the received abstract attributes values and the selected abstract data structure template, an abstract data structure defining a plurality of abstract attributes abstractly representing the data set in the graphical representation;
selecting transformation rules for transforming the abstract data structure into a concrete data structure from a plurality of transformation rules, the transformation rules describing graphical attributes of the requested graphical representation type; and
generating, on the basis of the abstract data structure, a concrete data structure defining a concrete graphical representation in a graphics rendering language using the transformation rules.

22. A computer-readable medium containing a program which, when executed by a processor, performs a process of generating a graphical representation of data, the process comprising:
generating an abstract data structure defining a plurality of abstract attributes representing an abstract graphical representation of the data; and
generating, on the basis of the abstract data structure, a concrete data structure defining a concrete graphical representation of the data in a graphics rendering language.

23. The computer-readable medium of claim 22, wherein the process further comprises:
retrieving a plurality of abstract data structure templates, each abstract data structure template being associated with a specific graphical representation type;
determining a requested graphical representation type;
selecting an abstract data structure template from the plurality of abstract data structure templates on the basis of the requested graphical representation type; and
generating the abstract data structure using the selected abstract data structure template.

24. The computer-readable medium of claim 23, wherein the requested graphical representation type is one of a bar chart, a line chart, a pie chart, a scatter plot and a combination thereof.

25. The computer-readable medium of claim 23, wherein the plurality of abstract data structure templates is associated with a particular data source of the data.

26. The computer-readable medium of claim 22, wherein the process further comprises:
retrieving transformation rules for transforming the abstract data structure into the concrete data structure, the transformation rules describing graphical attributes of a requested graphical representation type; and
generating the concrete data structure using the transformation rules.

27. The computer-readable medium of claim 26, wherein generating the concrete data structure using the transformation rules comprises:
selecting a subset of the transformation rules in accordance with the requested graphical representation type; and
generating the concrete data structure using the subset of the transformation rules.

28. The computer-readable medium of claim 27, wherein the requested graphical representation type is one of a bar chart, a line chart, a pie chart, a scatter plot and a combination thereof.

29. The computer-readable medium of claim 22, wherein at least one of the abstract data structure and the concrete data structure is defined in Extensible Markup Language (XML).

30. The computer-readable medium of claim 22, wherein the concrete data structure is defined in a vector-based graphics language.

31. The computer-readable medium of claim 30, wherein the vector-based graphics language is one of Vector Markup Language (VML), Scalable Vector Graphics (SVG), and Hypertext Markup Language (HTML) Image Maps.

32. A computer-readable medium containing a program which, when executed by a processor, performs a process of generating a graphical representation of data, the process comprising:
receiving a selection of a requested graphical representation type for a selected data set;
selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the requested graphical representation type;
generating, on the basis of the requested graphical representation type and the selected abstract data structure template, an abstract data structure defining a plurality of abstract attributes abstractly representing the data set in the graphical representation;
retrieving transformation rules for transforming the abstract data structure into a concrete data structure, the transformation rules describing graphical attributes of the requested graphical representation type; and
generating, on the basis of the abstract data structure, a concrete data structure defining a concrete graphical representation in a graphics rendering language using the transformation rules.

33. The computer-readable medium of claim 32, wherein the process further comprises:
rendering the data set, as described in the graphics rendering language, in a graphic.

34. The computer-readable medium of claim 32, wherein the graphical representation type is one of a bar chart, a line chart, a pie chart, a scatter plot and a combination thereof.

35. The computer-readable medium of claim 32, wherein the plurality of abstract data structure templates is associated with a particular data source of the data.

36. The computer-readable medium of claim 32, wherein the process further comprises:
selecting a subset of the transformation rules in accordance with the graphical representation type; and
generating the concrete data structure using the subset of the transformation rules.

37. The computer-readable medium of claim 32, wherein at least one of the abstract data structure and the concrete data structure is defined in Extensible Markup Language (XML).

38. The computer-readable medium of claim 32, wherein the concrete data structure is defined in a vector-based graphics language.

39. The computer-readable medium of claim 38, wherein the vector-based graphics language is one of Vector Markup Language (VML), Scalable Vector Graphics (SVG), and Hypertext Markup Language (HTML) Image Maps.

40. A computer-readable medium containing a program which, when executed by a processor, performs a process of generating an abstract data structure for a graphical representation of data, the process comprising:
retrieving a plurality of abstract data structure templates, each abstract data structure template being associated with a specific graphical representation type;
determining a requested graphical representation type;
selecting an abstract data structure template from the plurality of abstract data structure templates on the basis of the requested graphical representation type; and
generating an abstract data structure using the selected abstract data structure template.

41. A computer-readable medium containing a program which, when executed by a processor, performs a process of generating a graphical representation of data, the process comprising:
receiving a selection of a graphical representation type for a selected data set;
selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type;
generating, on the basis of the selected abstract data structure template, an abstract data structure defining a logical representation of the data set graphically represented according to the selected graphical representation type; and
transforming the abstract data structure into a graphics rendering language.

42. A computer-readable medium containing a program which, when executed by a processor, performs a process of generating a graphical representation of data, the process comprising:
receiving abstract attributes values comprising at least a selection of a requested graphical representation type for a selected data set;
selecting an abstract data structure template from a plurality of abstract data structure templates, each being specific to a different graphical representation type and defining a plurality of template attributes for for generically representing an abstract graphical representation in the respective different graphical representation type, wherein the selected abstract data structure template is specific to the selected graphical representation type;
generating, on the basis of the received abstract attributes values and the selected abstract data structure template, an abstract data structure defining a plurality of abstract attributes abstractly representing the data set in the graphical representation;
selecting transformation rules for transforming the abstract data structure into a concrete data structure from a plurality of transformation rules, the transformation rules describing graphical attributes of the requested graphical representation type; and
generating, on the basis of the abstract data structure, a concrete data structure defining a concrete graphical representation in a graphics rendering language using the transformation rules.

43. A computer, comprising:
a database having data; and
at least one graphics language framework residing in memory for generating graphics rendering language for the data, the at least one graphics language framework being configured for:
generating an abstract data structure defining a plurality of abstract attributes representing an abstract graphical representation of the data; and
generating, on the basis of the abstract data structure, a concrete data structure defining a concrete graphical representation of the data in a graphics rendering language.

44. A computer, comprising:
a database having data; and
at least one abstract data structure interface residing in memory for generating an abstract data structure for a graphical representation of the data, the at least one abstract data structure interface being configured for:
retrieving a plurality of abstract data structure templates, each abstract data structure template being associated with a specific graphical representation type;
determining a requested graphical representation type;
selecting an abstract data structure template from the plurality of abstract data structure templates on the basis of the requested graphical representation type; and
generating an abstract data structure using the selected abstract data structure template.

45. A computer, comprising:
a database having data; and
at least one graphics language framework residing in memory for generating graphics rendering language for the data, the at least one graphics language framework being configured for:
receiving a selection of a graphical representation type for a selected data set;
selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type;
generating, on the basis of the selected abstract data structure template, an abstract data structure defining a logical representation of the data set graphically represented according to the selected graphical representation type; and
transforming the abstract data structure into the graphics rendering language.

46. A computer, comprising:
a database having data; and
at least one graphics language framework residing in memory for generating graphics rendering language for the data, the at least one graphics language framework being configured for:
receiving a selection of a requested graphical representation type for a selected data set;
selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the requested graphical representation type;
generating, on the basis of the requested graphical representation type and the selected abstract data structure template, an abstract data structure defining a plurality of abstract attributes abstractly representing the data set in a graphical representation;
retrieving transformation rules for transforming the abstract data structure into a concrete data structure, the transformation rules describing graphical attributes of the requested graphical representation type; and
generating, on the basis of the abstract data structure, a concrete data structure defining a concrete graphics rendering language using the transformation rules.

47. A computer, comprising:
a database having data; and
at least one graphics language framework residing in memory for generating graphics rendering language for the data, the at least one graphics language framework being configured for:
receiving abstract attributes values comprising at least a selection of a requested graphical representation type for a selected data set;
selecting an abstract data structure template from a plurality of abstract data structure templates, each being specific to a different graphical representation type and defining a plurality of template attributes for generically representing an abstract graphical representation in the respective different graphical representation type, wherein the selected abstract data structure template is specific to the selected graphical representation type;
generating, on the basis of the received abstract attributes values and the selected abstract data structure template, an abstract data structure defining a plurality of abstract attributes abstractly representing the data set in the graphical representation;
selecting transformation rules for transforming the abstract data structure into a concrete data structure from a plurality of transformation rules, the transformation rules describing graphical attributes of the requested graphical representation type; and
generating, on the basis of the abstract data structure, a concrete data structure defining a concrete graphical representation in a graphics rendering language using the transformation rules.
